(19) United States
(12) Patent Application Publication
(10) Pub. No.: US 2007/0216507 A1
(43) Pub. Date: Sep. 20, 2007

(54) Electrical Contacting Of Thin Enameled Wires Of Secondary Windings Of Ignition Coils Having A Contact Crown And Contact Element

(76) Inventors: Bernd Fischer, Sulzberg (DE); Klaus Lerchenmueller, Immenstadt (DE); Konstantin Lindenthal, Blaichach (DE); Thomas Breckle, Bihlerdorf (DE); Juergen Raedler, Burgberg (DE); Werner Steinberger, Immenstadt (DE)

Correspondence Address: KENYON & KENYON LLP, ONE BROADWAY, NEW YORK, NY, 10004, US

(21) Appl. No.: 10/586,884

(22) PCT Filed: Dec. 13, 2004
(86) PCT No.: PCT/EP04/53410

§ 371 Date: May 25, 2007

(30) Foreign Application Priority Data
Jan. 21, 2004 (DE) 10 2004 002 935.0

(51) Int. Cl. H01F 27/29

(52) U.S. Cl. 336/192

(57) ABSTRACT

An electrical connection set-up for connecting thin enameled wires in ignition coils, which is to replace thermal methods, for example. This is achieved in that, to produce contacting between the winding and the respective high-voltage or low-voltage outlets, an individual contact element able to be slid over the winding by its one side and is fixed in place via its other side, the contact element having a spring-type design, a sliding surface, and at least on its one side fans out in a tulip-shape in the sliding direction, in such a way that the contact element presses against the winding in a spring-like manner in the mounted state and the insulation layer is ruptured and electrical contacting takes place.

The present invention relates to an electrical connection setup for manufacturing an ignition coil, particularly a rod-type ignition coil having an ignition coil rod with a high-voltage outlet as well as a low-voltage outlet.

### BACKGROUND INFORMATION

Ignition coils produce high-voltage sparks. This spark arcs between the electrodes of the spark plug set up at the ignition coil, thus igniting the air-gasoline mixture of an internal combustion engine, for example. Normally, this spark plug is supplied with high voltage from an ignition coil. A primary winding and a corresponding secondary winding are provided within the ignition coil. At one end, the primary winding is connected to an ignition and starting switch, while its other end is connected to a so-called contact breaker.

The secondary winding, that is, the winding responsible for generating the ignition spark, is connected in the interior of the ignition coil to the one end of the primary winding, so that it is grounded. The other end of the secondary winding is connected to the high-voltage outlet, which in turn is either connected to an ignition cable that leads to the spark plug, or at which the spark plug is set up directly.

The secondary winding itself is made of a thin wire coated with a suitable layer of enamel so as to avoid the contacting of the individual wires when wrapping a specific support part or coil shell. Once the secondary windings have been wound onto a shell, the ends of the respective wires are contacted. Normally, thermal contacting methods such as soldering or welding, for example, are known for this purpose.

### DISADVANTAGES OF THE RELATED ART

The contacting of the primary and secondary windings, in particular, requires different work processes. This entails higher installation costs, multiple assembly steps and also a certain number of connecting parts necessary to make an appropriate electrical connection.

Furthermore, in such a tight installation space, it was often difficult to bring about an appropriate contacting using the known thermal methods.

### OBJECTS OF THE INVENTION

The object of the present invention is to provide a connection setup between an ignition coil rod, an ignition coil and a secondary or primary winding which is inexpensive and readily implemented.

Attainment of the Objective

The basic principle for achieving the objective is to replace the thermal contacting method known per se from the related art. This is achieved by providing additional contacting elements that rupture the enamel-coated wire of the primary or secondary winding during installation, thus bringing about an appropriate contacting.

This objective is achieved by the features of claim 1.

### SUMMARY OF THE INVENTION

Compared to the previous method, the “cold” contacting method proposed here has the advantage that it involves no additional installation costs. Furthermore, the setup of the present invention makes it possible to reduce the number of assembly steps and also the number of connecting parts.

A further important advantage of the present invention is that the implementation of the contacting does not require the installation space to be optimized. That is to say, it will not be necessary to reserve free space in the area of contacting, e.g. for electrode holders, soldering irons or the like.

According to the present invention, a contact element is inserted on the side of the low-voltage outlet via guidance means. The contact element is designed such that the one end fans out in the sliding direction in a tulip shape and in this manner slides over the primary winding situated on the coil shell during the sliding operation. The other end is designed such that it is able to be fixed in position in a pocket.

For better sliding characteristics, the contact element additionally has a sliding surface pointing toward the primary winding.

By placing a primary coil shell over at least a portion of the coil shell, the free end of the contact element with its sliding surface is pressed down by a lip situated within the primary coil shell.

Once a defined position has been reached, the sliding surface of the contact element presses against the insulation-coated wires of the coil shell, which causes the insulation to be ruptured at the corresponding contact points, thus allowing an electrical contact to be produced between the individual wires of the coil shell and the contact element.

The contact element is preferably designed such that it has a waist to achieve its mechanical spring-type characteristics.

In particular on the side of the high-voltage outlet, the contact elements configured according to the present invention are combined in the form of a contact crown. On their sides facing away from the sliding surface, the individual contact elements according to the present invention are fixed in place on a ring element. This contact crown is preferably a one-piece component; the contact crown may conceivably be produced in a single working process (punching and bending).

When the contact crown is slipped over the secondary windings, the individual contact elements slide on the surface of the winding. The tulip-shaped design of the contact crown prevents the winding from being displaced or damaged. A limit stop, which simultaneously accommodates the end of the secondary winding in the form of a tie-up post, defines the position of the contact crown. This is also the result of the fact that the diameter of the contact crown is larger than the secondary coil shell plus two times the diameter of the secondary winding.

In a further step, a ring element is slipped over the contact crown, by which a press fit of the contact element on the secondary winding, and thus a contacting of the contact elements of the contact crown with the secondary winding, is achieved.

Further advantageous embodiments will become apparent from the following description as well as the drawings and the claims.

### BRIEF DESCRIPTION OF THE DRAWING THE FIGURES SHOW

FIG. 1 A perspective view of an ignition coil having one side for the high-voltage outlet and another side for the low-voltage outlet;

FIG. 2 A sectional view through the ignition coil according to FIG. 1;

FIG. 3 A perspective view of an ignition coil rod located in the ignition coil housing shown in FIG. 1;

FIG. 4 A perspective view of the side of the low-voltage outlet of an ignition coil;

FIG. 5 A perspective view of a contact element according to the present invention;

FIG. 6 A perspective view of the side of the low-voltage outlet of the ignition coil rod having the contact element of the present invention, according to FIG. 5;

FIG. 7 Another perspective view of the side of the low-voltage outlet of the ignition coil rod having the contact element of the present invention, according to FIG. 5, but without the secondary winding being shown;

FIG. 8 A perspective view of a contact crown according to the present invention, essentially made up of the contact elements according to FIG. 7;

FIG. 9 A perspective view of the side of the high-voltage outlet of an ignition coil with an illustration of the contact crown of the present invention, according to FIG. 8.

### DESCRIPTION OF AN EXEMPLARY EMBODIMENT

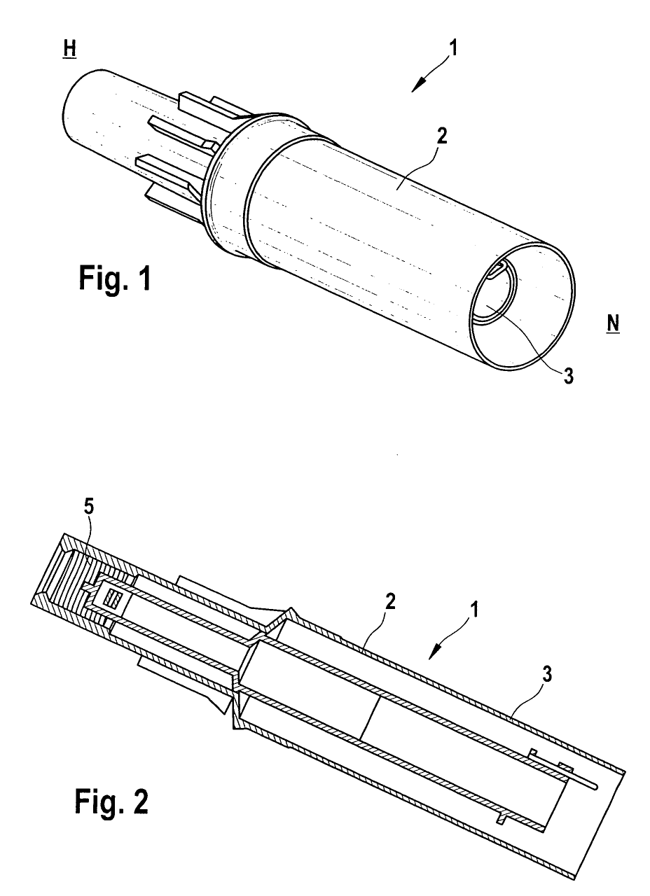

FIG. 1 shows a perspective view of an ignition coil 1. Ignition coil 1 includes an ignition coil housing 2 and an ignition coil rod 3 located in ignition coil housing 2. In addition, ignition coil 1 features a side for a high-voltage outlet H and a side for the low-voltage outlet N. The side of low-voltage outlet N is provided to establish contact with a power supply not detailed in the drawing, while the side of high-voltage outlet H is provided for connecting to an ignition cable or a spark plug not detailed in the drawing.

FIG. 2 shows a sectional view of ignition coil 1 illustrated in FIG. 1, the areas shown relating to essential features of the present invention which are shown in greater detail in the subsequent figures.

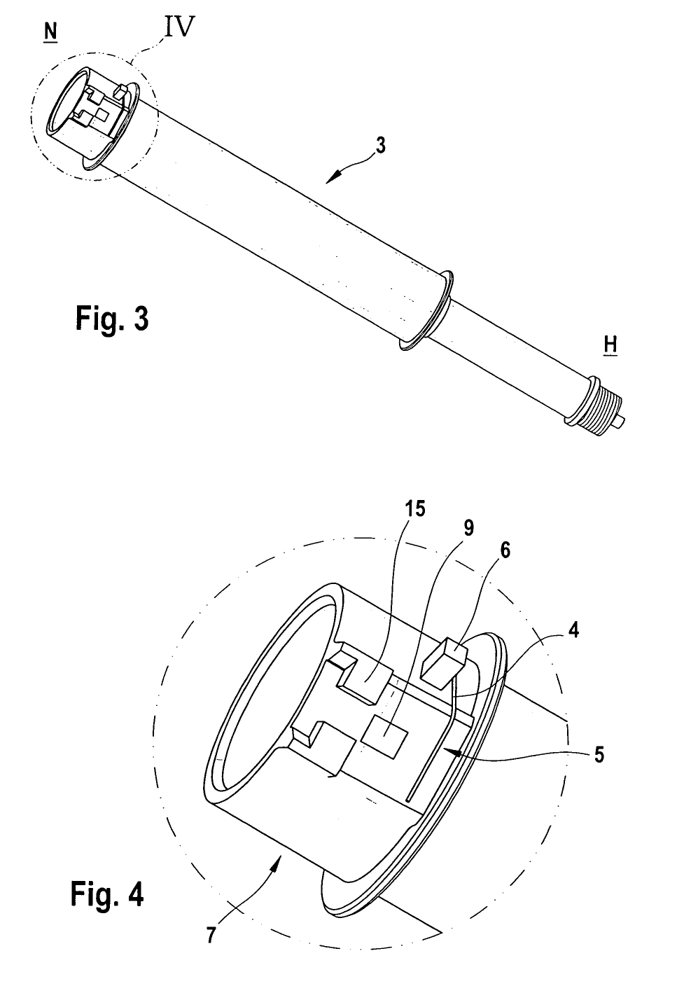

FIG. 3 shows ignition coil rod 3 having one side for high-voltage outlet H and one side for low-voltage-outlet N, which, immediately following its assembly, is insertable as a unit into ignition coil housing 2 illustrated in FIGS. 1 and 2.

Side of Low-Voltage Outlet N

FIG. 4 shows an enlarged representation of the side of low-voltage outlet N of an ignition coil 1. A wire is wound onto a coil shell 4, so that primary winding 5 provided here will result. One end of the wire of primary winding 5 is attached to a so-called tie-up post 6, from which the wire is wound onto the peripheral surface of coil shell 4 and extends over a defined contact area. This contact area at the same time serves as contacting area 7 for a contact element 8, shown in the additional figures, for establishing an electrical contact between primary winding 5 and contact element 8 itself.

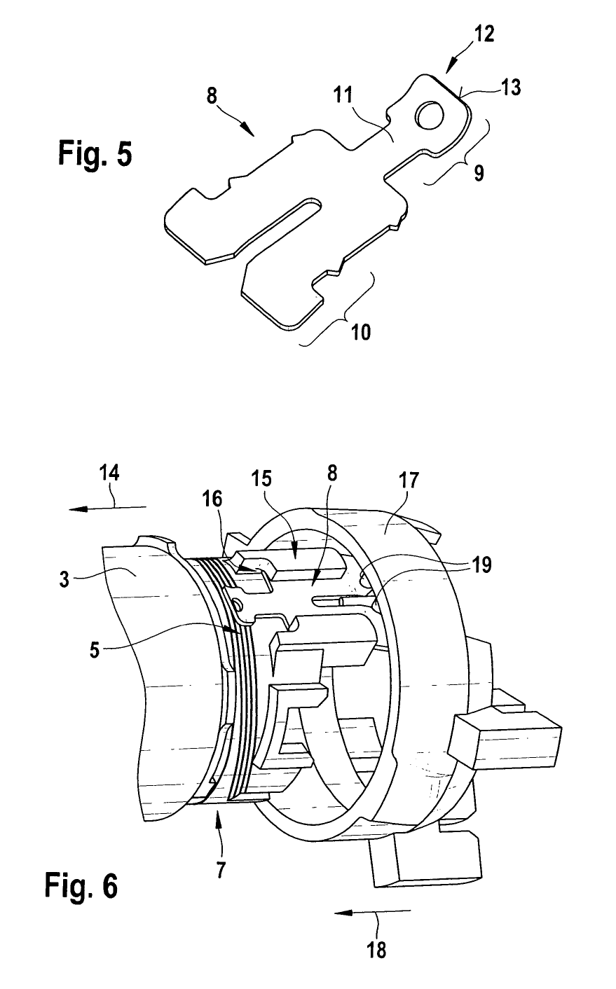

FIG. 5 shows contact element 8 according to the present invention. It is formed in one piece and essentially made up of two regions, i.e., a contact region 9 and a fixation region 10, the two regions being separated from one another by a waist 11. In particular in contact region 9, contact element 8 has a form that fans out in the shape of a tulip, and has on its one side 12 a sliding surface 13 which slides over contact region 9 of primary winding 5 during installation of contact element 8.

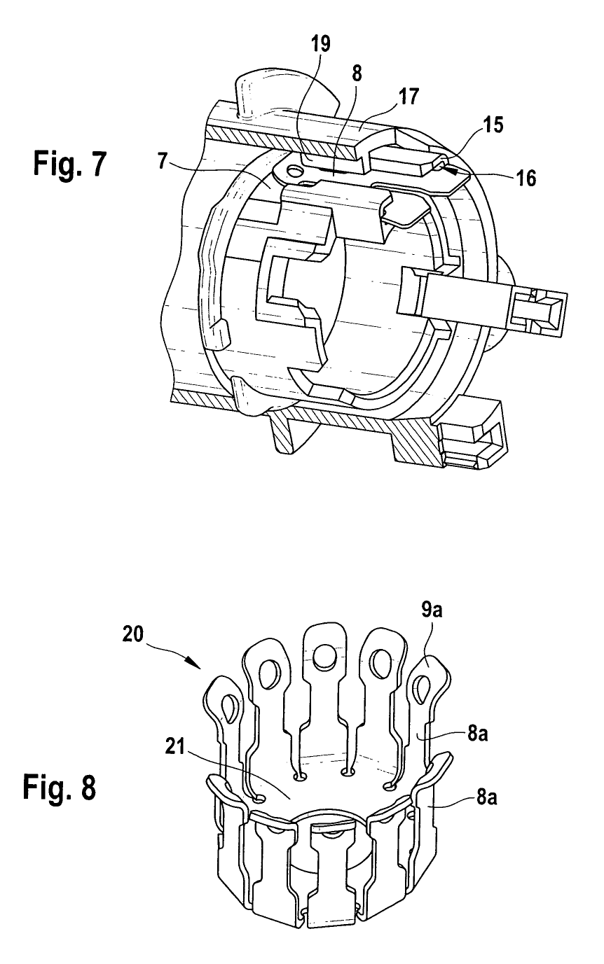

After primary winding 5 (cf. FIGS. 6 and 7) on coil shell 4 has been produced, contacting area 7 will be completely covered by primary winding 5. Subsequently, contact element 8 is slid over guide means 10 in the direction of arrow 14 according to FIG. 6. In the process, contact element 8 slides along contacting area 7 of primary winding 5 until it is fixed in place in the pocket-type form 16. In an additional step, a primary coil shell 17 is slipped over in the direction of arrow 18. Lips 19, which are disposed inside primary coil shell 17 and have the form of an anvil, in the mounted state of primary coil shell 17 press one side onto primary winding 5 and cause the insulating layer to rupture. Thus, an electrical connection has been established without the use of a thermal method.

Side of High-Voltage Outlet H

In another development, FIG. 8 shows a contact crown 20, which is made up of a plurality of contact elements 8 which are mounted in their fixation region 10 on a ring element 21. In the exemplary embodiment shown here, contact crown 20 has been formed in one piece. Individual contact elements 8 of contact crown 20 fan out in the direction of their contact regions 9 in the form of a tulip.

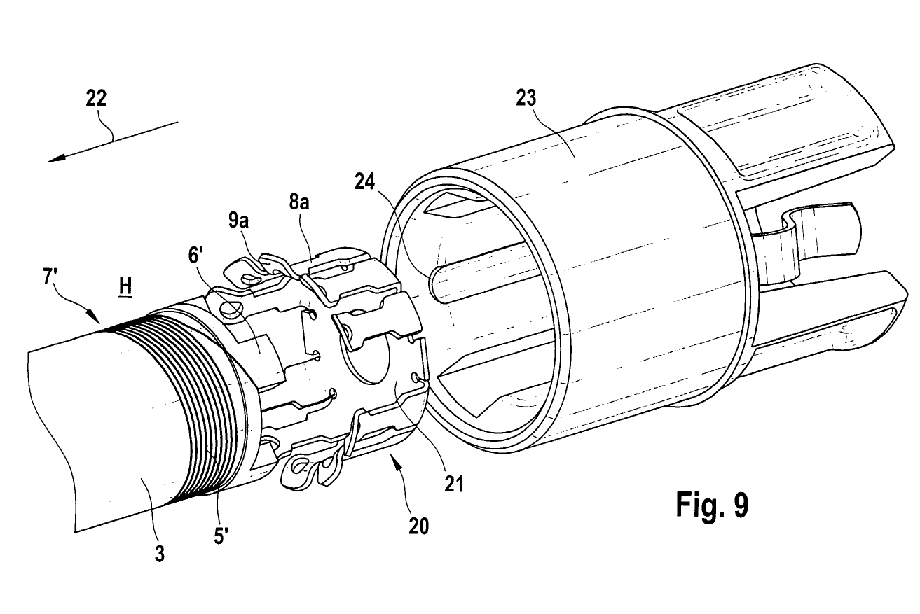

To install contact crown 20 according to FIG. 8 on a coil shell 4 (FIG. 9), cup-shaped contact crown 20 is slid onto the region of high-voltage outlet H of an ignition coil 1 in the direction of arrow 21, until ring element 21 has reached a tie-up post 6′. This type of design of a limit stop is used to produce a correctly implemented position of contact crown 20 with respect to contacting area 7 or 9 of secondary winding 5′ or contact elements 8.

Sliding a secondary coil shell 22 in the direction of arrow 18 causes contact regions 9 of the respective contact elements 8 to be pressed against secondary winding 5′ in its contacting area 7′ since lips 23 are likewise provided inside secondary coil shell 22, which press them against secondary winding 5′ in the installed state and thereby produce an electrical contacting by rupturing the insulation.

1-6. (canceled)

7. An electrical contacting of thin enameled wires in an ignition coil having a coil shell and provided with a high-voltage outlet and a low-voltage outlet, comprising:
a contacting area;
a contact element;
a wire that is wound onto the ignition coil and that is connectable in the contacting area with the contact element, the contact element destroying an enamel layer of the wire when contacting the wire, wherein:
the contact element is connectable to the coil shell,
a contact region of the contact element is able to slide over the wire in the contacting area, and
during installation of the ignition coil the contact region cooperates with a coil element that is able to be slipped over the contact element and presses the contact region against the wire in the process to destroy the enamel layer of the wire.

8. The electrical contacting as recited in claim 7, wherein the ignition coil includes a rod-type ignition coil.

9. The electrical contacting as recited in claim 7, wherein:
the contact element includes a fixation region that is able to be connected to the coil shell, and
the contact region forms an angle out of a plane of the fixation region, away from the contacting area.

10. The electrical contacting as recited in claim 9, wherein the coil shell includes a pocket-type receptacle for the fixation region.

11. The electrical contacting as recited in claim 7, wherein the coil element includes at least one lip for a defined generation of a contact pressure of the contact element on the wire.

12. The electrical contacting as recited in claim 7, further comprising:
a ring element; and
a plurality of further contact elements combined to form a contact crown, the further contact elements being disposed on the ring element.
